(19) United States
(12) Patent Application Publication
(10) Pub. No.: US 2015/0254188 A1
(43) Pub. Date: Sep. 10, 2015

(54) MEMORY SYSTEM AND METHOD OF CONTROLLING MEMORY SYSTEM

(71) Applicant: Kabushiki Kaisha Toshiba, Minato-ku (JP)

(72) Inventors: Hirokuni YANO, Ota (JP); Mitsunori TADOKORO, Fujisawa (JP); Norio AOYAMA, Machida (JP)

(73) Assignee: Kabushiki Kaisha Toshiba, Minato-ku (JP)

(21) Appl. No.: 14/466,008

(22) Filed: Aug. 22, 2014

Related U.S. Application Data
(60) Provisional application No. 61/950,589, filed on Mar. 10, 2014.

(51) Int. Cl. G06F 12/12

(52) U.S. Cl. CPC G06F 12/126; G06F 2212/1008; G06F 2212/60

(57) ABSTRACT

According to one embodiment, a controller registers first information to a first management table, and manage the first information, the first information being management information of data buffered in the buffer memory. When the data buffered in the buffer memory is flushed to the nonvolatile memory, the controller releases, from the first management table, the first information of the flushed data, and registers, to a second management table, and manages, the first information of the flushed data.

### CROSS-REFERENCE TO RELATED APPLICATIONS

This application is based upon and claims the benefit of priority from U.S. Provisional Patent Application No. 61/950,589, filed on Mar. 10, 2013; the entire contents of which are incorporated herein by reference.

### FIELD

Embodiments described herein relate generally to a memory system which includes a nonvolatile memory and a method of controlling the memory system.

### BACKGROUND

In a TLC (Triple Level Cell) flash memory, three-bit information can be stored in one memory cell. To these three bits, a lower page, a middle page, and an upper page are assigned. In the TLC flash memory, there is write-completed/read-inhibited data which cannot be read even when writing is completed, until a certain period of time elapses after the writing.

In a memory system which includes the TLC flash memory, it is necessary that such write-completed/read-inhibited data be managed in a buffer until the reading from the flash memory is allowed, in order that read data can be returned in response to a read request from a host.

### BRIEF DESCRIPTION OF THE DRAWINGS

FIG. 1 is a block diagram illustrating a configuration example of a memory system according to a first embodiment;

FIG. 2 is a diagram illustrating a buffer management table;

FIG. 3 is a diagram illustrating a NAND management table;

FIG. 4 is a diagram illustrating the arrangement of pages in a TLC NAND flash memory;

FIG. 5 is a block diagram illustrating a conceptual configuration example of the first embodiment;

FIG. 6 is a diagram illustrating pointers for managing the NAND;

FIG. 7 is a diagram illustrating pointers for managing a write buffer;

FIG. 8 is a diagram for describing a relation between an order of writing data into the NAND and data buffering in the write buffer;

FIG. 9 is a flowchart illustrating an operation procedure at the time of receiving a write command; and

FIG. 10 is a flowchart illustrating an operation procedure at the time of receiving a read command.

### DETAILED DESCRIPTION

According to an embodiment, a memory system includes a buffer memory, a nonvolatile memory which includes a plurality of blocks, each of the blocks being a unit of data erasing, and a controller. The controller writes data received from a host to the buffer memory in physical address order of the buffer memory. The controller performs flushing, the flushing including reading the data from the buffer memory in the physical address order of the buffer memory and writing the read data to the nonvolatile memory in a physical address order of the nonvolatile memory. The controller registers first information to a first management table, and manage the first information, the first information being management information of data buffered in the buffer memory. When the data buffered in the buffer memory is flushed to the nonvolatile memory, the controller releases, from the first management table, the first information of the flushed data, and registers, to a second management table, and manages, the first information of the flushed data.

A memory system and a method of controlling the memory system according to an embodiment will be described in detail with reference to the accompanying drawings. In addition, the invention is not limited to the embodiment.

### First Embodiment

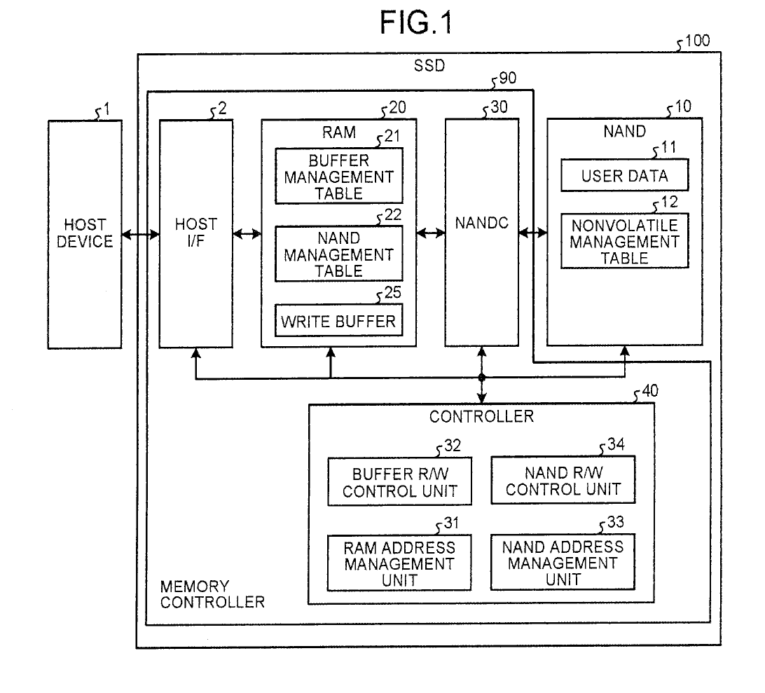

FIG. 1 is a block diagram illustrating a configuration example of a memory system 100. The memory system 100 is connected to a host device (hereinafter, abbreviated as a host) 1 through a host interface 2, and functions as an external storage device of the host 1. The host 1 is for example a personal computer, cell phone, imaging device, and the like.

The memory system 100 is configured with a NAND flash memory 10 (hereinafter, abbreviated as a NAND) as a nonvolatile semiconductor memory and a memory controller 90. The memory controller 90 includes the host interface 2, a RAM 20, a NAND controller (NANDC) 30, a controller 40, and the like. In addition, as the nonvolatile semiconductor memory, other memory such as ReRAM (Resistance Random Access Memory) may be employed as long as such a memory can store data in a TLC mode.

The NAND 10 stores user data 11 which is input from the host 1, or stores for backup, management information such as a buffer management table 21 and a NAND management table 22 managed in the RAM 20 as a nonvolatile management table 12. The NAND 10 includes one or more memory chips. Each memory chip includes a memory cell array in which a plurality of memory cells is arranged in a matrix. Each of the memory cells is a TLC memory cell, and one memory cell can store three-bit information. Each memory chip is configured by arranging a plurality of physical blocks, each of physical blocks is a unit of data erasing. The physical block is configured with a plurality of physical pages. As the physical page, a lower page, a middle page, and an upper page are included. In the NAND 10, data writing and data reading are performed per physical page.

The host I/F 2 acquires a command such as a read command and a write command from the host 1 through a communication interface such as SATA (Serial Advanced Technology Attachment) and SAS (Serial Attached SCSI). To the command, an address, a data size, data, and the like are added. When receiving the command from the host 1, the host I/F 2 informs the controller 40 of the command.

The RAM 20 includes a storage area which serves as a write buffer 25 to temporarily store data from the host 1 when the data is written in the NAND 10, a storage area which serves as the buffer management table 21 to manage the data buffered in the write buffer 25, a storage area which serves as the NAND management table 22 to manage the data stored in the NAND 10, a storage area which serves as a read buffer to temporarily store the data read from the NAND 10, and the like. The management information managed in the buffer management table 21 and the NAND management table 22 is backed up as the nonvolatile management table 12 in the NAND 10. As the RAM 20, SRAM (Static Random Access Memory) or DRAM (Dynamic Random Access Memory) is used.

The NANDC 30, for example, includes a NAND I/F which performs interfacing with the NAND 10, an error correction circuit, a DMA controller, and the like. Under the control of the controller 40, the NANDC 30 writes the data temporarily stored in the write buffer 25 into the NAND 10, and reads from the data stored in the NAND 10 to transmit the data to the RAM 20.

When making a request for reading or writing data to the memory system 100, the host 1 sends a command to which a logical address is added, to the memory system 100. The logical address, for example, is an LBA (Logical Block Addressing). The LBA is a logical address obtained by attaching a serial number from zero to a sector. In the embodiment, as a unit of managing data in the write buffer 25 and the NAND 10, there is defined a management unit called a cluster which is larger than a sector size and smaller than a physical block size.

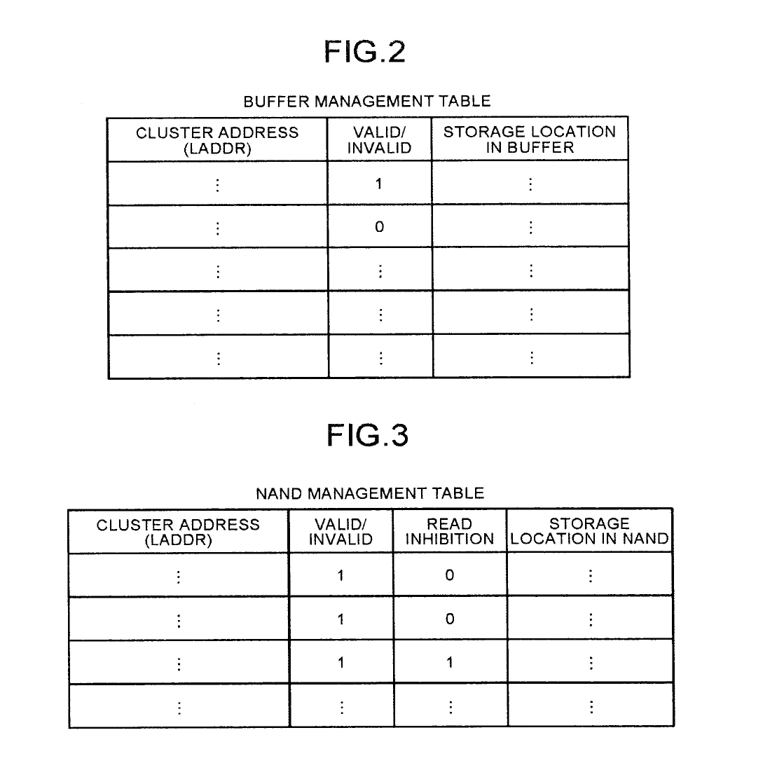

As illustrated in FIG. 2, in the buffer management table 21 managed in the RAM 20, a cluster address LADDR, a storage location (a storage location in the write buffer 25) in the RAM 20 in which cluster data corresponding to the cluster address LADDR is stored, and a cluster valid/invalid flag which indicates whether the cluster is valid or invalid are managed in correspondence with each other. The cluster address LADDR is obtained by dividing the LBA by a cluster size.

As illustrated in FIG. 3, in the NAND management table 22, the cluster address LADDR, a storage location (a storage location in the NAND) in the NAND 10 in which the cluster data is stored, and the cluster valid/invalid flag which indicates whether the cluster is valid or invalid are managed in correspondence with each other. The storage location in the NAND, for example, is expressed as Memory Chip Number+Physical Block Number+Physical Page Number+Storage Location in Page. Further, as to be described below, the NAND management table 22 is used to manage write-completed/read-inhibited data which cannot be read until a certain period of time elapses after the writing into the NAND 10 is completed. In addition, the write-completed/read-inhibited data may be managed by a pointer instead of the NAND management table 22 as to be described below.

In the memory system 100, a relation between the logical address (LBA) and the physical address (the storage location of the NAND 10) is not statically determined in advance and the logical addresses and the physical addresses are dynamically associated at the time of writing data. For example, when data having the same LBA is overwritten, the following processing is performed. It is assumed that valid data of block size is stored at the logical address A1 and a block B1 is used as the storage area. When a command of overwriting update data of block size of the logical address A1 is received from the host 1, one free block (a block B2) is secured and the data received from the host 1 is written into the free block. The free block is an unused block in which no valid data is contained. Then, the logical address A1 and the block B2 are associated with each other. As a result, the block B2 becomes an active block, and since the data stored in the block B1 becomes invalid, the block B1 becomes the free block. The active block is a block in which valid data is contained and which is in use.

In FIG. 1, the controller 40 includes a RAM address management unit 31, a buffer R/W control unit 32, a NAND address management unit 33, a NAND R/W control unit 34, and the like.

The RAM address management unit 31 manages correspondence between the cluster address LADDR and an address RADDR (the address of the write buffer 25) of the RAM 20 using the buffer management table 21. The RAM address management unit 31 performs translation from the LADDR into the RADDR, translation from the RADDR into the LADDR, making new correspondence (new mapping) between the LADDR and the RADDR, and cancellation (release) of the mapping

The buffer R/W control unit 32 controls the host I/F 2, and controls transmission of the user data between the host 1 and the RAM 20. Further, the buffer R/W control unit 32 controls reading (flushing) from the write buffer 25. The buffer R/W control unit 32 executes a control such that write data received from the host 1 is stored in the write buffer 25 of the RAM 20 through the host I/F 2. Further, the buffer R/W control unit 32 executes a control such that read data from the NAND 10 stored in the RAM 20, is sent to the host 1 through the host I/F 2. The buffer R/W control unit 32 requests the RAM address management unit 31 to map the cluster address LADDR onto the RAM address RADDR at the time of writing. When an amount of the data unwritten into the NAND 10 among data on the write buffer 25 exceeds a threshold, the buffer R/W control unit 32 flushes the data on the write buffer 25 to input the data to the NANDC 30. Further, the buffer R/W control unit 32 requests the NAND R/W control unit 34 to write the flushed data into the NAND 10.

The NAND address management unit 33 manages correspondence between the cluster address LADDR and an address PADDR of the NAND 10 using the NAND management table 22. The NAND address management unit 33 performs translation from the LADDR into the PADDR, translation from the PADDR into the LADDR, making new correspondence (new mapping) between the LADDR and the PADDR, and cancellation (release) of the mapping.

The NAND R/W control unit 34 controls the NANDC 30 to execute writing into and reading from the NAND 10. At the time of writing in the NAND 10, the NAND R/W control unit 34 determines a writing location PADDR on the NAND 10 for the user data flushed from the write buffer 25, and informs the NANDC 30 of the determined writing location PADDR. The NANDC 30 stores the data flushed from the write buffer 25 at the informed writing location PADDR. After the data is stored in the NAND, the NAND R/W control unit 34 requests the NAND address management unit 33 to map the cluster address LADDR onto the address PADDR of the NAND 10. At the time of reading, the NAND R/W control unit 34 requests the NAND address management unit 33 to translate the cluster address LADDR into the address PADDR of the NAND 10, and informs the NANDC 30 of the obtained address PADDR. Further, the NAND R/W control unit 34 informs the buffer R/W control unit 32 that the reading from the NAND 10 occurs. The NANDC 30 reads the data of the informed address PADDR from the NAND 10. The buffer R/W control unit 32 writes the data read from the NAND 10 by the NANDC in the RAM 21.

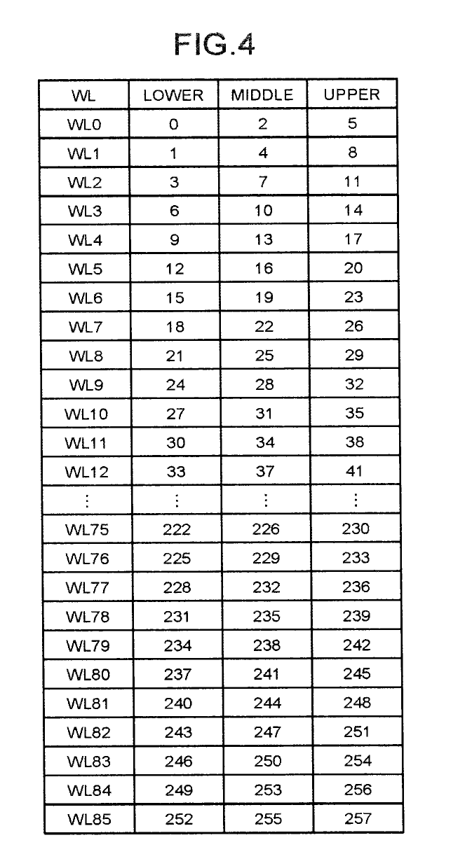

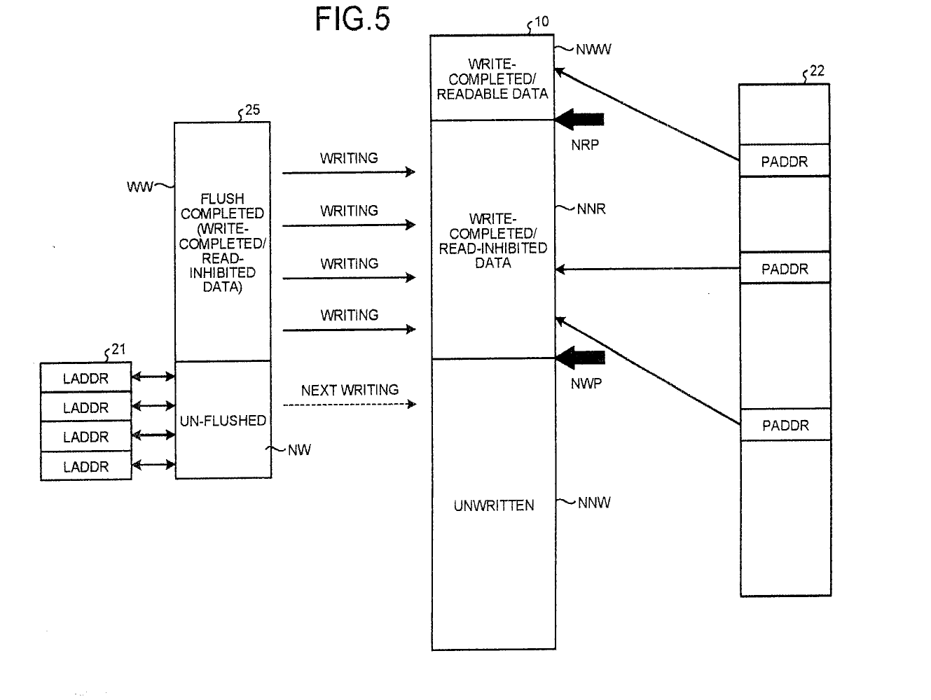

An order of writing to the TLC NAND 10 will be described using FIG. 4. FIG. 4 illustrates the order of writing into one block. One block is configured with a plurality of memory cells connected to a plurality of word lines WL0 to WLm. In one memory cell, three-bit data is stored. To the three bits, the lower page, the middle page, and the upper page are assigned. In FIG. 4, one block is configured with 258 pages from page 0 to page 257. The attached numbers in FIG. 4 are numbers indicating the writing order. Further, in the embodiment, the page number is matched with the number indicating the writing order for the convenience of explanation, but another method of numbering the pages may be employed.

As illustrated in FIG. 4, the writing is performed on the respective pages in the order such as the lower page 0 of WL0, the lower page 1 of WL1, the middle page 2 of WL0, the lower page 3 of WL2, the middle page 4 of WL1, the upper page 5 of WL0, the lower page 6 of WL3, the middle page 7 of WL2, the upper page 8 of WL1, . . . , the lower page 252 of WL85, the middle page 253 of WL84, the upper page 254 of WL83, the middle page 255 of WL85, the upper page 256 of WL84, and the upper page 257 of WL85. In other words, when the lower page is denoted by L, the middle page by M, and the upper page by U, the writing is performed in the page order of L→L→M→L→M→U→L→M→U→ . . . →L→M→U→M→U→U.

In other words, in the NAND 10, the writing is performed in the order of the lower page of the word line (n+2), the middle page of the word line (n+1), and the upper page of the word line (n) except the head and tail of the block.

Further, in the case of the writing into the TLC NAND 10, assuming that m is a natural number, the data of the lower page, the data of the middle page and the data of the upper page on the same word line WLm are required for writing the lower page of WLm; the data of the lower page, the data of the middle page and the data of the upper page on the same word line WLm are required for writing the middle page of WLm; and the data of the lower page, the data of the middle page and the data of the upper page on the same word line WLm are required for writing the data of the upper page of WLm. In other words, the data of the lower page of WLm and the data of the middle page of WLm needs to be stored in the write buffer 25 until the writing of the data of the upper page of WLm is completed. Further, in the order of writing into the TLC NAND 10, three word lines are related to one writing cycle of L→M→U. Therefore, in the case of the TLC NAND 10, there is such a first constraint that the data of WL(n+1) and WL(n+2) has to be stored on the write buffer 25 at the point of time when the writing into WL(n) is completed. In other words, even after the writing on the upper page 20 of WL5 is completed, the data already written on the lower page 15 of WL6 and the data already written on the middle page 19 of WL6 has to be stored on the write buffer 25 in order to perform the writing on the upper page 23 of WL6. Similarly, even after the writing on the upper page 20 of WL5 is completed, the data already written on the lower page 18 of WL7 has to be stored on the write buffer 25 in order to perform the writing on the middle page 22 of WL7 or the upper page 26 of WL7.

Further, in the TLC NAND 10, it is necessary to complete the writing of WLm+1 in order to read the data of WLm. In other words, even when the writing of the data to WLm−1 is completed, the data of WLm−1 cannot be read until the writing on the upper page of WLm is completed. In other words, there is such a second constraint that the data of WLm−1 can be read after the writing on the upper page of WLm is completed. In addition, the last word line is an exception of the second constraint, and the reading is allowed at the point of time when the writing to the upper page is completed.

Under such first and second constraints, in the TLC NAND 10, when the writing of WL(n) is completed, the data of WL(n), WL(n+1), and WL(n+2) needs to be buffered on the write buffer 25.

In this way, the write-completed/read-inhibited data of which writing to the NAND 10 has been completed but which is not allowed to be read front the NAND 10 needs to be buffered to the write buffer 25 until the reading from the NAND 10 is allowed. In other words, the write-completed/read-inhibited data is stored in both the write buffer 25 and the NAND 10.

In a comparative example, since the write-completed/read-inhibited data is present on the NAND 10 and the write buffer 25, the write-completed/read-inhibited data is managed in both the buffer management table 21 and the NAND management table 22. Therefore, in the comparative example, when a read request for the write-completed/read-inhibited data is issued, the data can be acquired front the write buffer 25 using the management data of the buffer management table 21. In this case, the write-completed/read-inhibited data comes to be managed in both the buffer management table 21 and the NAND management table 22.

Therefore, in the embodiment:

(1) Entries on the buffer management table 21 related to the data which has been written into the NAND 10 are all invalidated (released) at the point of time when the writing into the NAND 10 is completed, regardless of whether or not the data is not readable. In other words, the data flushed from the write buffer 25 to the NAND 10 is released from the buffer management table 21 at the stage of being flushed.

(2) When reading of the write-completed/read-inhibited data occurs, an address of read target data stored in the write buffer 25 of the write-completed/read-inhibited data is obtained by calculation, the write-completed/read-inhibited data is read from the write buffer 25 using the calculated address, and the read data is sent to the host 1.

(3) In order to enable the above calculation, data is written into the write buffer 25 in the cluster unit in accordance with the order of receiving from the host 1 and the order of the physical addresses of the write buffer 25. Further, the cluster data is read from the write buffer 25 in the order of writing to the write buffer 25. Further, the cluster data read from the write buffer 25 is written in the reading order in accordance with the order of the physical addresses of the NAND 10.

FIG. 5 illustrates a conceptual configuration of the memory system according to the first embodiment. The data stored in the NAND 10 includes write-completed/readable data NWW which has been written to and is allowed to be read, and write-completed/read-inhibited data NNR which has been written to but is not allowed to be read. Besides, there is an unwritten area NNW. On the other hand, the data buffered in the write buffer 25 includes two types of data such as write-completed/read-inhibited data WW which has been written (flushed) to the NAND 10 and is not allowed to be read, and data NW which is unwritten to the NAND 10. The data WW includes only the write-completed/read-inhibited data NNR but not the data NWW. In this way, the write-completed/read-inhibited data is managed as the data WW in the write buffer 25, and managed as the data NNR in the NAND 10.

In the NAND management table 22, the write completed/readable data NWW and the write-completed/read-inhibited data NNR are managed. In the buffer management table 21, the data NW which is not written into the NAND 10 is managed, but the data WW which has been written into the NAND 10 is not managed.

When write data from the host 1 is written into the write buffer 25 of the RAM 20, the buffer R/W control unit 32 divides the write data received from the host 1 into data of cluster size in the reception order, and writes the divided data of cluster size sequentially from a predetermined head address of the RAM 20 such that the reception order is matched with the address order of the RAM 20. Further, when the data of the write buffer 25 is flushed, the buffer R/W control unit 32 makes a control such that the data buffered first is the first to be flushed according to a FIFO (First In, First Out) scheme.

On the other hand, when the data flushed from the write buffer 25 is written into the NAND 10, the NAND R/W control unit 34 performs the writing similarly to the writing into the RAM 20. In other words, the NAND R/W control unit 34 writes the cluster data flushed from the write buffer 25 in the flushing order sequentially from a predetermined address of the NAND 10. In one block, the cluster data is written on each page such that the order of flushing from the write buffer 25 is matched with the order of writing into the NAND 10 illustrated in FIG. 4. When data is written on the last page of one block, the writing is similarly performed from a head address of the next block.

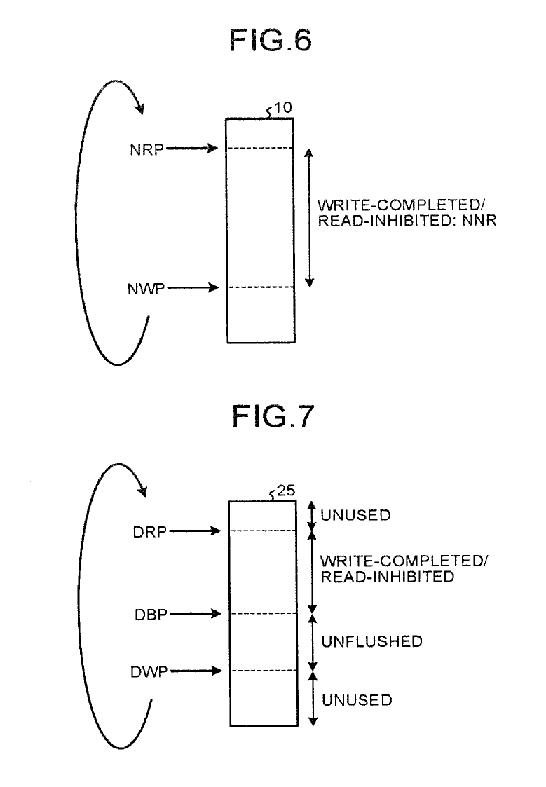

The NAND R/W control unit 34 controls the writing into the NAND 10 using two pointers NRP and NWP as illustrated in FIGS. 5 and 6. The read inhibition pointer NRP indicates a head of an area in which the write-completed/read-inhibited data NNR is stored. In other words, the read inhibition pointer NRP indicates an area where the oldest write-completed/read-inhibited data NNR is stored. The read inhibition pointer NRP increases when the writing into the NAND 10 is performed and the readable area in the NAND 10 becomes widen. The write pointer NWP indicates a next location where the data flushed from the write buffer 25 is written. The write pointer NWP increases when the data flushed from the write buffer 25 is written to the NAND 10. When reaching the end of a block, these pointers NRP and NWP move to the head of a next block to be written.

FIG. 7 illustrates three pointers DRP, DBP, and DWP which are used by the buffer R/W control unit 32. The buffer R/W control unit 32 manages the write buffer 25 using these three pointers DRP, DBP, and DWP. The write buffer 25 is a ring buffer, and when increasing up to the last of the write buffer, the respective pointers DRP, DBP, and DWP return to the head. Each of the pointers DRP, DBP, and DWP cannot overtake a preceding pointer. An increment unit of each of the pointers DRP, DBP, and DWP is same as that of the pointers NRP and NWP used for managing the NAND 10. The increment unit of these pointers, for example, is a cluster size or a page size.

The read inhibition pointer DRP indicates a location of the head of the write buffer 25 where the write-completed/read-inhibited data WW is stored. The pointer DBP indicates the head of the unflushed data area. The write pointer DWP indicates a next location where the data from the host 1 is written. The area between the pointers DWP and DRP indicates an unused area in the write buffer 25.

The DRP is interlocked with the NRP, and increases as the NRP increases. In an area after the area pointed by the DRP, the release of data is not allowed, but in an area before the area pointed by the DRP, the release of data is allowed.

The DBP is interlocked with the NWP. The DBP increases when the data is flushed and written into the NAND 10. The DWP increases when the data from the host 1 is buffered in the write buffer 25.

As described above, in the buffer management table 21, only the unflushed data NW is managed and the write-completed/read-inhibited data WW is not managed. A minimum size of management target data in the buffer management table 21 is set to 12 pages (3 pages×4 word lines) in order that the data of the lower page, the middle page, and the upper page of the same word line can be managed (see FIG. 4).

Therefore, the data from the DBP to the DWP gains entry into the buffer management table 21, and the address of the data is managed. When the DBP is made increase, the management information of the data written in the NAND 10 is released from the buffer management table 21. For making the DWP increase, a space is necessary for the increment in the buffer management table 21. In other words, when the buffer management table 21 is full, the data from the host 1 cannot be written into the write buffer 25, and thus the DWP cannot be made increase. When the data amount from the DBP to the DWP exceeds a predetermined threshold C, the data from the DBP to the DWP is flushed and then written into the NAND 10. When the unused area is not present in the write buffer 25 (a state where the DWP catches up with the DRP), and in a case where the entries of the buffer management table 21 are full, the write data from the host 1 cannot be written into.

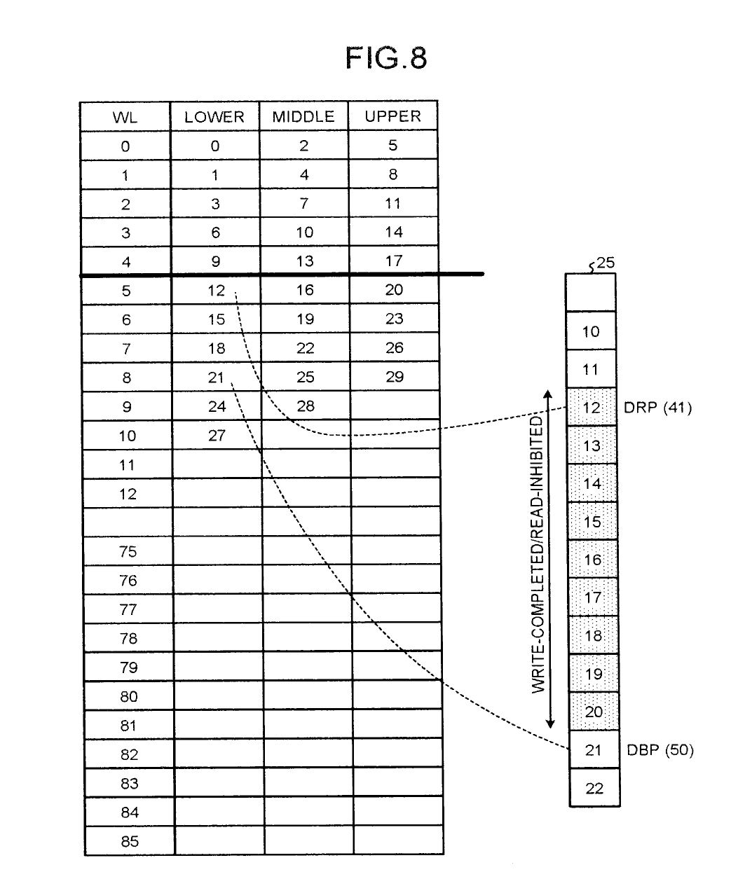

A relation between an order of writing data into the NAND 10 and data buffering in the write buffer 25 will be described using FIG. 8. In the write buffer 25, the data to be written on the lower page 0 of WL0, the lower page 1 of WL1, the middle page 2 of WL0, the lower page 3 of WL2, the middle page 4 of WL1, the upper page 5 of WL0, the lower page 6 of WL3, the middle page 7 of WL2, the upper page 5 of WL1, . . . , and so on of the NAND 10 is buffered in this order. In FIG. 8, the numbers attached in the write buffer 25 correspond to the order of writing the data into the NAND 10. When the unflushed data in the write buffer 25 is accumulated equal to or more than the predetermined threshold C, the data is flushed in the writing order and written into the NAND 10 in the flushing order.

Now, it is assumed that the writing to the NAND 10 has been completed up to page 20. In this state, at the NAND 10 side, NRP=12·(WL5-Lower), and the data of the word lines WL0 to WL4 before NRP=12 is allowed to be read under the second constraint. Further, NWP=21·(WL8-Lower). Therefore, the data from NRP=12 to NRP=20 comes to be managed as the write-completed/read-inhibited data NNR. In other words, when the writing on the upper page of WL(n) is completed, the data written from the lower page of WL(n) to the upper page of WL(n) comes to be managed as the write-completed/read-inhibited data NNR according to the writing order. Assuming that n=5, when the writing on the upper page 20 of WL(5) is completed, the data written from the lower page 12 of WL(5) to the upper page 20 of WL(n) comes to be managed as the write-completed/read-inhibited data NNR.

At the write buffer 25 side, for example, assuming that DBP=50, the data of page 21 which is the next data to be written to the NAND 10 comes to be contained at the location of DBP=50. The DRP indicates the address of the write buffer 25 which corresponds to NRP=12·(WL5-Lower), resulting in DRP=DBP−(NWP−NRP)=50−(21−12)=41. Therefore, when the writing into the NAND 10 has been completed up to page 20, the data from page 12 to page 20 is buffered as the write-completed/read-inhibited data WW, and the data from page 21 and the subsequent pages is buffered as the unflushed data NW in the write buffer 25. The area at the addresses lower than the pointer address=40 among the write buffer 25 is released.

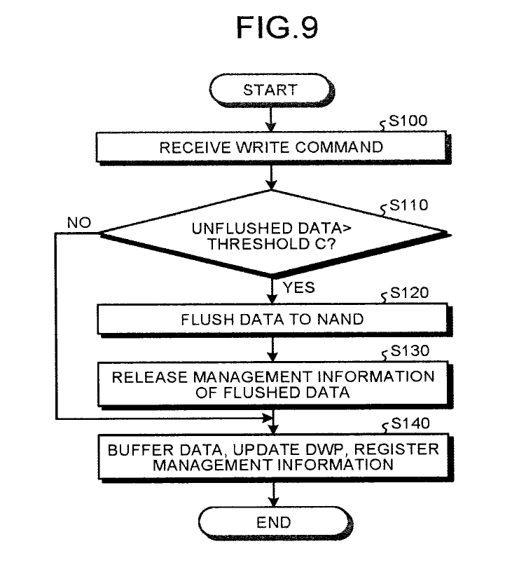

The operation of the memory system 100 at the time of writing will be described using FIG. 9. When receiving a write command (Step S100), the buffer R/W control unit 32 determines whether or not an amount of the unflushed data (the data unwritten into the NAND 10) among the data buffered in the write buffer 25 exceeds the predetermined threshold C (Step S110). The unflushed data can be obtained by a difference between the pointer DWP and the pointer DBP.

When the amount of the unflushed data exceeds the threshold C, the buffer R/W control unit 32 flushes the data of the write buffer 25 present between the pointer DWP and the pointer DEP to the NAND 10 (Step S120). Specifically, the buffer R/W control unit 32 reads the data of the write buffer 25 to output the data to the NANDC 30, and informs the NAND R/W control unit 34 of the cluster address of the flushed data. The NAND R/W control unit 34 determines the writing location PADDR on the NAND 10 of the flushed data, and informs the NANDC 30 of the determined writing location PADDR. The NANDC 30 stores the data flushed from the write buffer 25 at the informed writing location PADDR on the NAND 10.

When the data is flushed, the buffer R/W control unit 32 informs the RAM address management unit 31 of the cluster address LADDR of the flushed data. The RAM address management unit 31 releases (invalidates) the entry at the informed cluster address LADDR to exclude the flushed data from the management target of the buffer management table 21 (Step S130).

Then, the buffer R/W control unit 32 buffers the write data from the host 1 in the write buffer 25, and updates the pointer DWP. Further, the RAM address management unit 31 registers the management information of the buffered write data with the buffer management table 21 (Step S140).

On the other hand, when the NANDC 30 completes the writing of the data into the next writing location, the NAND R/W control unit 34 updates the pointer NWP. The buffer R/W control unit 32 is informed of the updating of the pointer NWP, and the updating of the pointer DBP is thereby performed. Thereafter, when the writing on the upper page of the NAND 10 is completed and the data of a certain WL is decided on, the NAND R/W control unit 34 increases the read inhibition pointer NRP. As the read inhibition pointer NRP is updated, the pointer DBP is also updated. As denoted by the number “12” in FIG. 8, the read inhibition pointer NRP points to the physical address of the lower page of the word line (WL=5 in FIG. 5) into which the writing is completed.

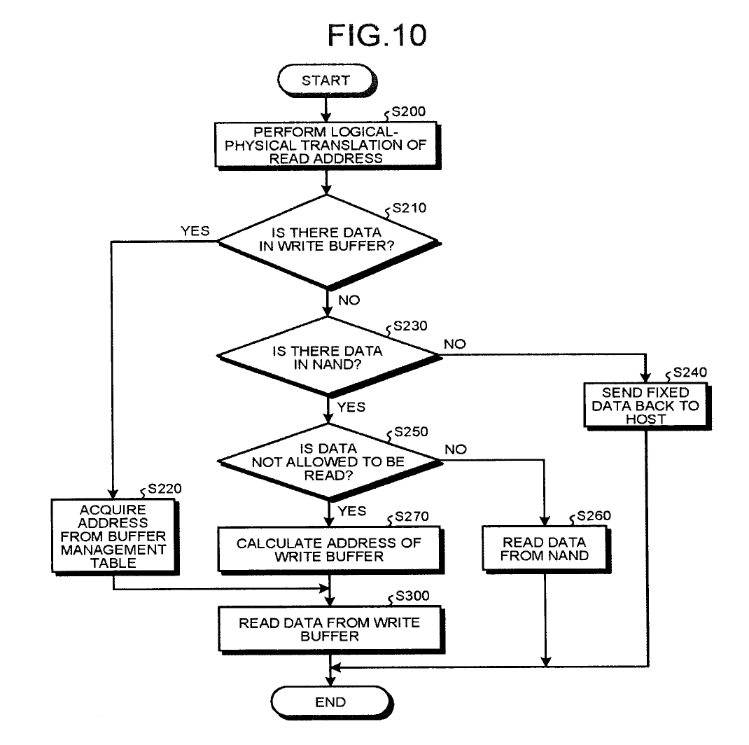

The operation of the memory system 100 at the time of reading will be described using FIG. 10. When a read command is input, the buffer R/W control unit 32 makes a request to the RAM address management unit 31 for executing a logical-physical translation to determine whether or not the data at the cluster address LADDR requested by the read command is in the write buffer 25 (Step S200). The RAM address management unit 31 retrieves the buffer management table 21, checks whether or not the entry corresponding to the cluster address LADDR requested by the read command is in the buffer management table 21 (Step S210), and reports the retrieval result to the buffer R/W control unit 32.

When the result of the determination of Step S210 is Yes, the RAM address management unit 31 acquires from the buffer management table 21 the physical address of the RAM 20 in which the data at the cluster address LADDR is buffered (Step S220), and informs the buffer R/W control unit 32 of the acquired physical address. The buffer R/W control unit 32 reads the cluster data requested by the read command from the write buffer 25 using the informed physical address (Step S300), and sends the read data to the host 1 through the host I/F 2. In this way, when the unflushed data NW buffered in the write buffer 25 is designated by the read command, the read operation is performed using the management information of the buffer management table 21.

When the result of the determination of Step S210 is No, the buffer R/W control unit 32 passes the read command to the NAND R/W control unit 34, and makes a request for reading the data from the NAND 10. The NAND R/W control unit 34 makes a request to the NAND address management unit 33 for determining whether or not the data at the cluster address LADDR requested by the read command is in the NAND 10 (Step S230). The NAND address management unit 33 retrieves the NAND management table 22, checks whether or not the entry corresponding to the cluster address LADDR requested by the read command is in the NAND management table 22 (Step S230), and reports the retrieval result to the NAND R/W control unit 34.

When the result of the determination of Step S230 is NO, the NAND R/W control unit 34, for example, considers the cluster address as an unwritten one and sends fixed data set in advance back to the host 1 (Step S240). When the result of the determination of Step S230 is Yes, the NAND address management unit 33 acquires from the NAND management table 22 the physical address PADDR of the NAND 10 in which the cluster address LADDR is stored, and informs the NAND R/W control unit 34 of the acquired physical address PADDR. The NAND R/W control unit 34 determines whether or not the informed physical address PADDR is included between the pointer NPR and the pointer NWP in order to determine whether or not the physical address PADDR of the read data is the write-completed/read-inhibited data NNR (Step S250).

When the determination of Step S250 is No, the NAND R/W control unit 34 controls the NANDC 30 so as to read the data at the physical address PADDR out of the NAND 10 (Step S260). Thereby, the data is read from the NAND 10, and transmitted to the host 1 through the NANDC 30, the RAM 20, and the host I/F 2. In this way, when the write-completed/readable data NWW stored in the NAND 10 is designated by the read command, the read operation from the NAND 10 is performed using the management information of the NAND management table 22.

On the other hand, when the determination of Step S250 is Yes, the NAND R/W control unit 34 informs the buffer R/W control unit 32 of the data necessary for calculating an address (an address in the write buffer 25) on the RAM 20 in which the data at the cluster address LADDR is stored, in order to read the data from the write-completed/read-inhibited data WW of the write buffer 25.

The address DP of the data on the RAM 20 is derived by Equation (1) as follows.

DP=(DBP+(NP−NWP+BS))mod BS (1)

Here, PADDR=NP; PADDR is the physical address which is subjected to the logical-physical translation in the NAND management table 22. Further, mod represents a residual PADDR, and BS represents the size of the write buffer 25. Equation (1) above uses the fact that a difference between the location NP on the NAND 10 and the pointer NWP corresponds to a difference between the pointer DBP of the write buffer 25 and the location of the read data on the write buffer 25. In the above equation, when NP=NWP, the DBP becomes the buffer address at which the data of the NP is located.

In FIG. 8, the buffer address when NP=16 becomes as follows.

DP=(50+(16−21+BS))mod BS=45

The NAND R/W control unit 34 informs the buffer R/W control unit 32 of the physical address NP of the data acquired in the NAND management table 22 and of the pointer value NWP. The buffer R/W control unit 32 acquires the pointer DBP and the buffer size BS besides the physical address NP informed from the buffer R/W control unit 32 and the pointer NWP, and substitutes these values into Equation (1) above to calculate the address DP of the data on the RAM 20 (Step S270). The NAND R/W control unit 34 reads the data from the write buffer 25 using the calculated address DP (Step S300), and transmits the read data to the host 1 through the host I/F 2. In this way, when the write-completed/read-inhibited data NNR stored in the NAND 10 is designated by the read command, the read operation from the write buffer 25 is performed using the address obtained by calculation.

According to such an embodiment, when the data buffered in the write buffer 25 is flushed to the NAND 10, the management information of the flushed data is released from the buffer management table 21, and thus it is possible to reduce a memory capacity as much as the management information of the write-completed/read-inhibited data that is not being stored in the buffer management table 21. Further, when the read request is made for the write-completed/read-inhibited data, an address on the write buffer 25 in which the write-completed/read-inhibited data is buffered is obtained by calculation, the write-completed/read-inhibited data is read from the write buffer 25 using the calculated address, and the read data is sent to the host 1. Therefore, even when the management information of the write-completed/read-inhibited data is not present in the buffer management table 21, it is possible to reliably read the write-completed/read-inhibited data from the write buffer.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory system comprising:
a buffer memory;
a nonvolatile memory including a plurality of blocks, each of the blocks being a unit of data erasing; and
a controller configured to:
write data received from a host to the buffer memory in physical address order of the buffer memory, and
perform flushing, the flushing including reading the data from the buffer memory in the physical address order of the buffer memory and writing the read data to the nonvolatile memory in a physical address order of the nonvolatile memory,
wherein the controller is configured to:
register first information to a first management table, and manage the first information, the first information being management information of data buffered in the buffer memory, and
when the data buffered in the buffer memory is flushed to the nonvolatile memory, release, from the first management table, the first information of the flushed data, and register, to a second management table, and manage, the first information of the flushed data.

2. The memory system according to claim 1, wherein the controller is configured to:
divide, and manage, a data area of the nonvolatile memory into a first area in which write-completed/readable data from the nonvolatile memory is stored, a second area in which write-completed/read-inhibited data from the nonvolatile memory is stored, and a third area in which no data is stored, and
divide, and manage, a data area of the buffer memory into a fourth area in which the data stored in the second area is buffered, a fifth area in which data unflushed to the nonvolatile memory is buffered, and a sixth area in which no data is buffered.

3. The memory system according to claim 2,
wherein the controller registers second information to the first management table, and does not register third information to the first management table, the second information being management information of data stored in the fifth area, the third information being management information of data stored in the fourth area.

4. The memory system according to claim 3,
wherein the controller registers fourth information and fifth information to the second management table, the fourth information being management information of data stored in the first area, the fifth information being management information of data stored in the second area.

5. The memory system according to claim 4,
wherein when a read request for first data stored in the second area is issued, the controller reads data corresponding to the read request from the fourth area.

6. The memory system according to claim 5,
wherein the controller calculates a physical address in which the data requested to be read is stored in the buffer memory, based on a first physical address and a difference between a second physical address and a third physical address, the first physical address being a top physical address of the fifth area, the second physical address being a physical address in which the data requested to be read in the nonvolatile memory is stored, the third physical address being a top physical address of the third area.

7. The memory system according to claim 2,
wherein the controller performs the flushing, when an amount of the data stored in the fifth area exceeds a predetermined threshold.

8. The memory system according to claim 1, wherein the nonvolatile memory includes a plurality of word lines, each of the word lines being connected to a plurality of memory cells, each of the memory cells being capable of storing three bits, and
wherein the controller writes, in writing order of a lower page of a word line (n+2), a middle page of a word Line (n+1), and an upper page of a word line (n), where n is zero or a natural number.

9. The memory system according to claim 8,
wherein when writing to the upper page of the word line (n) is completed, the controller manages second data stored in the second area, the second area being to be written from a lower page of the word line (n) to the upper page of the word line (n) in accordance with the writing order.

10. The memory system according to claim 9,
wherein the controller stores, in the buffer memory, third data to be written to the lower page of a first word line among the word lines, fourth data to be written to the middle page of the first word line, and fifth data to be written to the upper page of the first word line, and
wherein, when writing to the nonvolatile memory, the controller writes to the upper page, using the third data, the fourth data, and the fifth data.

11. A method of controlling a memory system, the memory system including a buffer memory, and a nonvolatile memory, the nonvolatile memory including a plurality of blocks, each of the blocks being a unit of data erasing, the method comprising:
writing data received from a host to the buffer memory in physical address order of the buffer memory,
performing flushing, the flushing including reading the data from the buffer memory in the physical address order of the buffer memory and writing the read data to the nonvolatile memory in a physical address order of the nonvolatile memory,
registering first information to a first management table, and managing the first information, the first information being management information of data buffered in the buffer memory, and
when the data buffered in the buffer memory is flushed to the nonvolatile memory, releasing, from the first management table, the first information of the flushed data, and registering, to a second management table, and managing, the first information of the flushed data.

12. The method according to claim 11, further comprising:
dividing, and managing, a data area of the nonvolatile memory into a first area in which write-completed/readable data from the nonvolatile memory is stored, a second area in which write-completed/read-inhibited data from the nonvolatile memory is stored, and a third area in which no data is stored, and
dividing, and managing, a data area of the buffer memory into a fourth area in which the data stored in the second area is buffered, a fifth area in which data unflushed to the nonvolatile memory is buffered, and a sixth area in which no data is buffered.

13. The method according to claim 12, further comprising:
registering second information to the first management table, and not registering third information to the first management table, the second information being management information of data stored in the fifth area, the third information being management information of data stored in the fourth area.

14. The method according to claim 13, further comprising:
registering fourth information and fifth information to the second management table, the fourth information being management information of data stored in the first area, the fifth information being management information of data stored in the second area.

15. The method according to claim 14, further comprising:
when a read request for first data stored in the second area is issued, reading data corresponding to the read request from the fourth area.

16. The method according to claim 15, further comprising:
calculating a physical address in which the data requested to be read is stored in the buffer memory, based on a first physical address and a difference between a second physical address and a third physical address, the first physical address being a top physical address of the fifth area, the second physical address being a physical address in which the data requested to be read in the nonvolatile memory is stored, the third physical address being a top physical address of the third area.

17. The method according to claim 15, further comprising:
performing the flushing, when an amount of the data stored in the fifth area exceeds a predetermined threshold.

18. The method according to claim 11, wherein the nonvolatile memory includes a plurality of word lines, each of the word lines being connected to a plurality of memory cells, each of the memory cells being capable of storing three bits,
the method further comprising:
writing, in writing order of a lower page of a word line (n+2), a middle page of a word line (n+1), and an upper page of a word line (n), where n is zero or a natural number.

19. The method according to claim 18, further comprising:
when writing to the upper page of the word line (n) is completed, managing second data stored in the second area, the second area being to be written from a lower page of the word line (n) to the upper page of the word line (n) in accordance with the writing order.

20. The method according to claim 19, further comprising:
storing, in the buffer memory, third data to be written to the lower page of a first word line among the word lines, fourth data to be written to the middle page of the first word line, and fifth data to be written to the upper page of the first word line, and
when writing to the nonvolatile memory, writing to the upper page, using the third data, the fourth data, and the fifth data.
